(19) United States
(12) Patent Application Publication
(10) Pub. No.: US 2026/0081430 A1
(43) Pub. Date: Mar. 19, 2026

(54) MINIMUM-RESOURCE, MULTIPLE-MICROGRID BLACK START DRIVEN BY GRID FORMING INVERTERS

(71) Applicant: Siemens Corporation, Washington, DC (US)

(72) Inventors: Abhishek Banerjee, Princeton, NJ (US); Elliott Fix, Princeton, NJ (US); Ulrich Muenz, Princeton, NJ (US)

(73) Assignee: Siemens Corporation, Washington, DC (US)

(21) Appl. No.: 19/108,759

(22) PCT Filed: May 31, 2023
(86) PCT No.: PCT/US2023/023935

§ 371 Date: Mar. 5, 2025

Related U.S. Application Data
(60) Provisional application No. 63/375,101, filed on Sep. 9, 2022.

(51) Int. Cl. H02J 3/44; H02J 3/08; H02J 3/38

(52) U.S. Cl. CPC H02J 3/44; H02J 3/08; H02J 3/381

(57) ABSTRACT

Methods for performing a black start in a power system and corresponding systems. A method (200) includes starting (100) a first anchor grid-forming inverter (122) in a first microgrid (110) and starting (100) a second anchor grid-forming inverter (122) in a second microgrid (120). The first microgrid (110) is connected to a first bus (118) and the second microgrid (120) is connected to a second bus (128). The method includes measuring (202) a first voltage at the first bus (118) and measuring a second voltage at the second bus (128), determining (204) a voltage difference between the first bus (118) and the second bus (128), and determining (204) whether the voltage difference is within a voltage difference threshold (350). The method includes measuring (206) a first phase angle at the first bus (118) and measuring a second phase angle at the second bus (128), determining (208) a phase angle difference between the first bus (118) and the second bus (128), and determining (208) whether the phase angle difference is within a phase angle difference threshold (360). The method includes, when the voltage difference is within the voltage difference threshold (350) and the phase angle difference is within the phase angle difference threshold (360), then operatively connecting (212) the first bus (118) to the second bus (128).

### CROSS-REFERENCE TO OTHER APPLICATION

This application claims the benefit of the filing date of U.S. Provisional Patent Application 63/375,101, filed Sep. 9, 2022, which is hereby incorporated by reference.

### GOVERNMENT LICENSE RIGHTS

This invention was made with government support under DE-EE0008769 awarded by the United States Department of Energy. The government has certain rights in the invention.

### TECHNICAL FIELD

The present disclosure is directed, in general, to power generation and distribution systems and in particular, to systems and methods for operation of electric power systems that include invertor-based resources.

### BACKGROUND OF THE DISCLOSURE

More frequent natural disasters due to climate change and threats of cyber-physical attacks cause power systems to be more vulnerable to outages. Considerable progress has been made in the decarbonization of the energy sector with the increase of renewable energy penetration via inverter-based resources. Distributing inverter-based resources across the power system also increases its resilience to cyber-physical attacks. However, restarting a portion of the electrical grid from a blackout condition (a “black start”) can prove challenging in power systems incorporating inverter-based resources. Improved systems are desirable.

### SUMMARY OF THE DISCLOSURE

The present disclosure includes microgrid black-start technologies with grid-forming inverter-based resources and includes black start and interconnection methods for 100% inverter-based microgrids. Various embodiments include a multiple-microgrid technique that provides significant technical advantages over existing methods. Disclosed systems include intelligent synchronization units that enable the autonomous synchronization of multiple microgrids based on their terminal measurements. In various embodiments, microgrids are held at different loading levels and comprise averaged models of grid-forming microgrid inverters.

Various disclosed embodiments include methods for performing a black start in a power system and corresponding systems. A method includes starting a first anchor grid-forming inverter in a first microgrid and starting a second anchor grid-forming inverter in a second microgrid. The first microgrid is connected to a first bus and the second microgrid is connected to a second bus. The method includes measuring a first voltage at the first bus and measuring a second voltage at the second bus, determining a voltage difference between the first bus and the second bus, and determining whether the voltage difference is within a voltage difference threshold. The method includes measuring a first phase angle at the first bus and measuring a second phase angle at the second bus, determining a phase angle difference between the first bus and the second bus, and determining whether the phase angle difference is within a phase angle difference threshold. The method includes, when the voltage difference is within the voltage difference threshold and the phase angle difference is within the phase angle difference threshold, then operatively connecting the first bus to the second bus.

Various embodiments also include determining whether an enable signal is active, and only operatively connecting the first bus to the second bus when the enable signal is active. In various embodiments, the first phase angle and the second phase angle are measured using phase locked loop.

Various embodiments also include thereafter starting at least one other inverter in the first microgrid. Various embodiments also include thereafter operatively connecting at least one other microgrid to the first microgrid and the second microgrid based on a voltage difference and a phase angle difference between the other microgrid and the connected first microgrid and second microgrid.

In various embodiments, each microgrid includes multiple other inverters, and each of the other inverters in each microgrid are started at random after the first microgrid has been operatively connected to the second microgrid.

In various embodiments, the first anchor grid-forming inverter and the second anchor grid-forming inverter each produce three-phase electric power, and the measuring and determining steps are each performed with respect to corresponding phases of first bus and the second bus.

Disclosed embodiments include a power system having a plurality of microgrids, with each microgrid having a plurality of inverter-based resources, at least one inverter-based resource in each microgrid being an anchor grid-forming inverter, and each microgrid operatively connectable to at least one other microgrid by a synchrobreaker. Such a power system can be configured to perform processes di.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIGS. 1A-1C illustrate an example of a power system and black-start process in accordance with disclosed embodiments;

FIG. 2 illustrates an example of a process in accordance with disclosed embodiments;

FIG. 3 illustrates various connection criteria in a phasor diagram for connecting a first microgrid and a second microgrid in accordance with disclosed embodiments; and

FIGS. 4A-4C illustrate exemplary frequency plots of a minimum-resource, multiple-microgrid black start process in accordance with disclosed embodiments.

### DETAILED DESCRIPTION

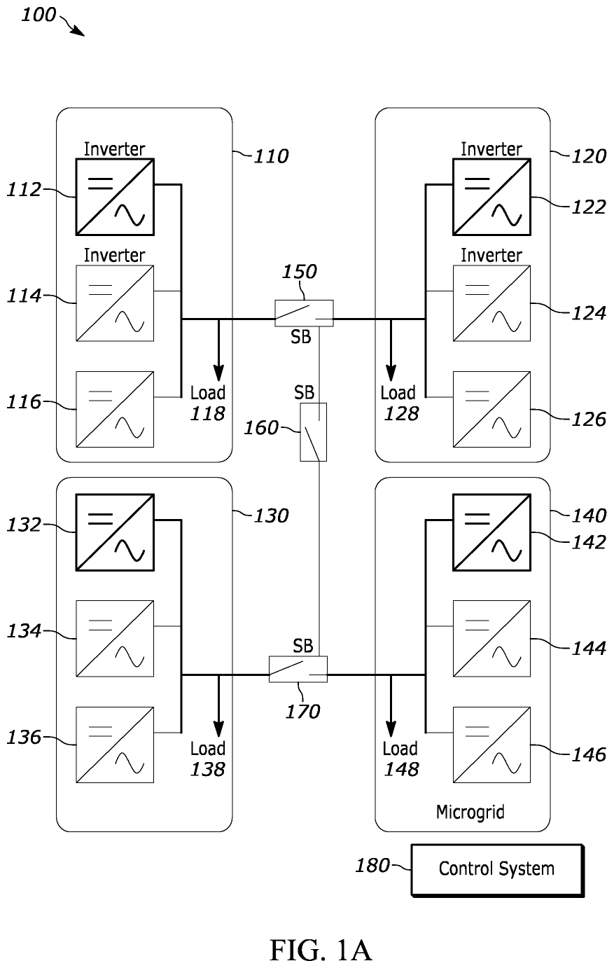

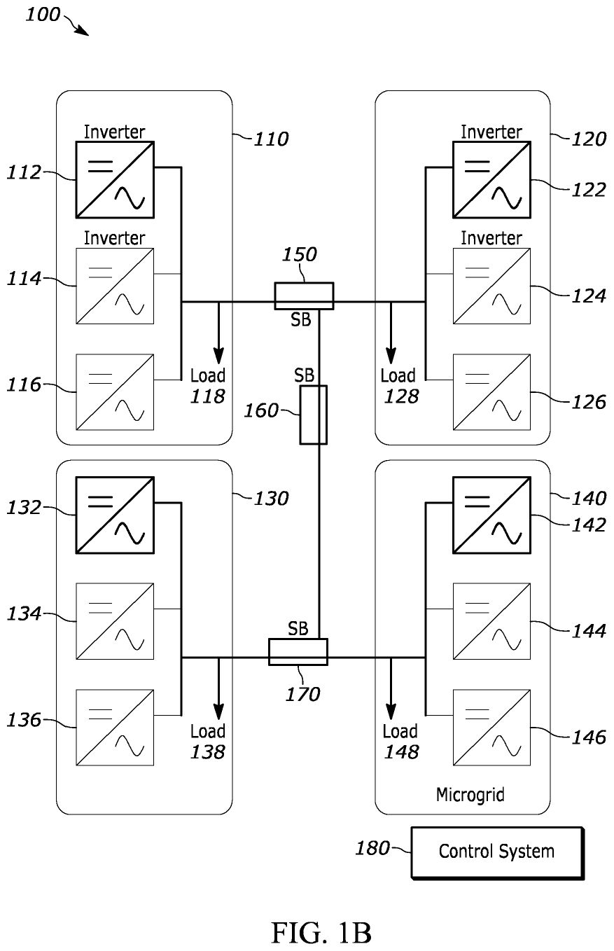

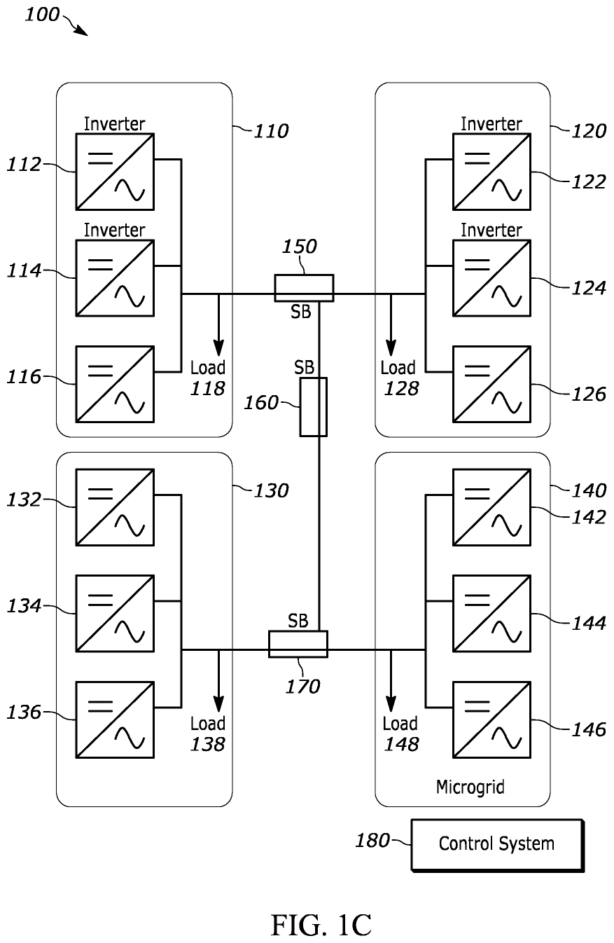

FIGS. 1A through 4C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

A microgrid (MG) is a group of interconnected loads and distributed energy resources (DERs) within clearly defined electrical boundaries that acts as a single controllable entity with respect to the grid. In many cases, an MG comprises low-voltage distribution systems with distributed energy resources (microturbines, fuel cells, photovoltaics, etc.), storage device (batteries, flywheels) energy storage systems, and flexible loads. An MG can connect and disconnect from the grid to enable it to operate in both connected or “island” mode. Increasingly, today's electric power systems are rapidly transitioning from being largely or entirely comprised of large synchronous generators toward having an increasing proportion of generation from nontraditional sources, such as wind, solar, energy storage devices such as batteries, and others. In addition to the variable nature of many renewable generation sources, these newer sources vary in size from residential-scale rooftop systems to utility-scale power plants and are interconnected throughout the electric grid both from within the distribution system and directly to the high-voltage transmission system. Many of these new resources are connected to the power system through power electronic inverters rather than spinning electromechanical machines. These inverter-based resources (IBRs) can be used or combined into MGs, and these MGs can present particular challenges with regard to startup and synchronization within the larger grid.

More frequent natural disasters due to climate change and threats of cyber-physical attacks cause power systems to be more vulnerable to outages. Considerable progress has been made in the decarbonization of the energy sector with the increase of renewable energy penetration via inverter IBRs, and distributing IBRs across the power system also increases its resilience to cyber-physical attacks. As renewable IBRs replace fossil fuels, they must support the robust control and reliability functions provided by traditional generation, from voltage/frequency control to black-start recovery procedures. Black-start recovery procedures are particularly complex with IBR MGs.

A black start is a power system contingency plan that reenergizes a grid after a blackout. Black starting MGs is a critical topic for future power systems to fully incorporate IBR technology. Inverter-based MGs have more generation units in a smaller footprint, shorter interconnections, and a proportionally more-diverse assortment of inverter technologies than bulk power systems. For these reasons and others, the MG black-start process is quite complex.

The majority of IBR technology developed has been centered on IBR controls for normal operation, e.g., voltage and frequency control, and fault supports, such as fault ride-through, but does not address the complex issues of black-start recovery in inverter-based MGs formed substantially or entirely of GFMs. Simple, fast, and robust black start strategies must be developed to combat such contingencies. In the event of a black start, the faster one can connect multiple MGs together, the larger one can build system inertia and the quicker critical loads can be energized.

Disclosed embodiments address these shortcomings by describing systems and methods for 100% inverter-based MGs and their subsequent synchronization, with minimal human interaction. Disclosed techniques provide specific and substantial technical advantages over other approaches with regard to critical load recovery time and frequency stabilization with more GFM assets. Other black start methods completely energize MGs before synchronization, thus at higher power levels there is expected to be greater frequency and voltage deviations due to large, instantaneous power share between MGs when they are physically connected, and disclosed techniques overcome these disadvantages

Disclosed multi-MG black start techniques solve the problem of coordinated control of multiple inverter-based MG and minimize the impact of MG connection, synchronization, and generation/load switching events. By prioritizing the interconnection of multiple MGs before their maximum local generation capacity has been reached, systems as disclosed herein reduce sudden changes in current and therefore power, reduce voltage disturbances, and minimize frequency sag/spike.

Disclosed techniques include a minimum-resource, multiple-microgrid black start approach that requires only one grid-forming inverter to be connected and supporting a voltage on each load bus before interconnection, minimizing the power level upon interconnection and therefore reducing the impact of breaker closure.

The disclosed techniques for multi-MG system black starts have other particular advantages in remote, isolated locations or those that have lost their bulk power system connection.

The disclosed black-start methods provide yet further technical advantages in requiring minimal communication. The minimal control necessary is a single on/off enable signal to each inverter.

Another advantage is that disclosed methods can be applied to 100% inverter-based resources and do not require current industry-common diesel-based black start units.

One particular component of disclosed multi-MG black start systems is a synchrobreaker (SB) that enables the synchronization of MGs by producing a trip/block signal to a connected physical relay placed in between the MGs. A SB as disclosed herein can be implemented using software/microcontroller unit coupled with a controllable circuit-breaker (CCB) such as the Siemens TAPAS inverter boards (SBs) connected to commercially available relays.

To determine if two MG buses can be operatively connected (that is, physically or electrically connected, directly or indirectly, to share power), the SB reads the local voltage waveform on both buses to which is connected. The SB measures and evaluate five metrics (collectively, the “connection criteria”): each of the phase A, B, and C voltage differences must be within the voltage difference threshold, the phase angle difference measured via phase-lock-loop (PLL) on each of the two buses must be within the phase difference threshold, and the SB must be given an enable signal. When these conditions are met, the breaker closes and the MGs are coupled. No standard thresholds exist for the interconnection of MGs or the connection of individual GFM IBRs to islanded MGs during black starts. In section 4.10 of IEEE Std. 1547-2018, standards are established for an inverter to enter service, including frequency, voltage, and phase differences for synchronous interconnection. The difference in frequency between two MGs can be described as:

$$Δ {f}_{ij} = {m}_{d} ( \frac{{p}_{i}}{{n}_{i}} - \frac{{p}_{j}}{{n}_{j}} )$$

where Δfᵢⱼ is frequency deviation between MG i and j, m_{d} is inverter frequency droop gain, pᵢ and pⱼ are baseline loading, and nᵢ and nⱼ are generation capacity factor with the same y-axis intercept assumed.

A synchronization method is required to minimize the disturbances of a weak, low-inertia MG when connecting additional energy sources, e.g., GFM inverters.

FIGS. 1A-1C illustrate an example of a power system in accordance with disclosed embodiments, including multiple microgrids and synchrobreakers, used to illustrate an example of a process in accordance with disclosed embodiments.

In the example of FIGS. 1A-1C, a power system 100 is comprised of multiple microgrids 110, 120, 130, and 140, each microgrid connected to a respective bus. Different implementations may have different numbers of microgrids.

Each microgrid 110, 120, 130, and 140 includes multiple grid-forming inverters. Microgrid 110 includes grid-forming inverters 112, 114, and 116. Microgrid 120 includes grid-forming inverters 122, 124, and 126. Microgrid 130 includes grid-forming inverters 132, 134, and 136. Microgrid 140 includes grid-forming inverters 142, 144, and 146. Different implementations may have more or fewer grid-forming inverters in each microgrid. As known to those of skill in the art, the grid-forming inverters in this example are three-phase power generators, with voltage output connections at phase A, phase B, and phase C.

Each microgrid 110, 120, 130, and 140, and its respective grid-forming inverters, is connected to a load bus (and via the load bus, to a load). Microgrid 110 is connected to load bus 118. Microgrid 120 is connected to load bus 128. Microgrid 130 is connected to load bus 138. Microgrid 140 is connected to load bus 148.

As noted above, a power system implemented in accordance with disclosed embodiments may have more or fewer microgrids. In addition, some microgrids may include mechanical/machine electric generators in addition or in place of grid-forming inverters.

The microgrids 110, 120, 130, and 140 are interconnected by synchrobreakers. In this example, microgrid 110 is operatively connected to microgrid 120 by SB 150, and microgrid 130 is operatively connected to microgrid 140 by SB 170. Further, microgrids 110 and 120 are operatively connected to microgrids 130 and 140 by SB 160, which connects SB 150 and SB 170. In other implementations, using different numbers of microgrids, additional SBs are used as described herein to selectively interconnect each of the microgrids as they meet the criteria to be brought online. Each SB is connected and configured to measure the phase voltage, the phase voltage differences, the phase differences, the frequency, and other aspects of its connected grid-forming inverters and microgrids. Not shown in these figures, each SB can but is not required to be connected to a control system 180 that can generate enable signals and other control signals and commands.

As described herein, each SB enables the synchronization and then physical connection of MGs. To determine if two MG buses can be operatively connected, the SB reads the voltage waveform on both buses or devices that it is connected to. In this example SB 150 is connected to the IBRs of microgrids 110 and 120, SB 170 is connected to the IBRs of microgrids 130 and 150, and SB 160 is connected to SB 150 and SB 170.

The connection criteria must be met before the SB activates (closes the breaker) to operatively connect the respective devices. In a three-phase system as illustrated in FIGS. 1A-1C, the connection criteria include determining that the phase A, B, and C voltage differences are within a voltage difference threshold, the phase angle difference on each of the two buses is within a phase difference threshold, and the SB has received an enable signal.

In implementations with single phase systems, the connection criteria can be simpler. In these implementations only one phase voltage difference must be checked in addition to the phase angle difference and the enable signal.

In the example of FIGS. 1A-1C, thick or bolded lines are used to represent connections and devices that are active or powered, and regular lines are used to represent connections and devices that are inactive.

The following description illustrates a minimum-resource, multiple-microgrid black start in accordance with disclosed embodiments. FIG. 1A illustrates the initial black start of the power system 100. In FIG. 1A, a single grid-forming inverter in each microgrid has come online and is active. Grid-forming inverter 112 is online and connected to load 118, grid-forming inverter 122 is online and connected to load 128, grid-forming inverter 132 is online and connected to load 138, grid-forming inverter 142 is online and connected to load 148. The initial active grid-forming inverters in each microgrid can be referred to as the “anchor” grid-forming inverter or anchor IBR. Further, while all of the IBRs in FIGS. 1A-1C are represented as grid-forming inverters, each MG can have any combination of grid-following and grid-forming inverters provided that the anchor IBM in each MG is a grid-forming black start inverter. That is, the anchor IBR, in various embodiments, is a grid-forming, black-start-capable inverter, while the other IBRs in each MG need not be a grid-forming inverter or a black-start-capable inverter.

At this point, in this example, SB 150 begins analyzing the connection criteria with respect to grid-forming inverter 112 of microgrid 110 and grid-forming inverter 122 of microgrid 120 (the only active grid-forming inverters). SB 170 begins analyzing the connection criteria with respect to grid-forming inverter 132 of microgrid 130 and grid-forming inverter 142 of microgrid 140. If the connection criteria is met (including an enable signal to the respective SB), the SB operatively connects the respective grid-forming inverters (which may also be referred to as “power injection”). SB 150 connects microgrid 110 to microgrid 120. SB 170 connects microgrid 130 to microgrid 140.

When SB 150 and SB 170 are active, SB 160 can then analyze the connection criteria with respect to SB 150 and SB 170 and their respective combined microgrids. That is, SB 160 can measure the voltage, phase, frequency, and other factors of each of the combined microgrids according to their connected SBs, then analyze the connection criteria according to the voltage, phase and frequency differences. If the connection criteria is met (including an enable signal to the connecting SB, SB 160), SB 160 operatively connects the SB 150 to SB 170, thereby connecting all of the microgrids 110, 120, 130, 140, with only one active grid-forming inverter in each microgrid.

FIG. 1B illustrates this state of the example power system 100. In this case, grid-forming inverter 112 of microgrid 110, grid-forming inverter 122 of microgrid 120, grid-forming inverter 132 of microgrid 130, and grid-forming inverter 142 of microgrid 140 are active, as are the connecting SBs 150, 160, and 170. Power system 100 is operational from cold start, without requiring all grid-forming inverters to be active. This is a significant advantage over other systems which much bring all grid-forming inverters online and perform power balancing only at that time.

The power system 100 can then continue to bring other grid-forming inverters online, while the SBs monitor the connection criteria against the possibility of desynchronization and the need to disconnect a microgrid.

FIG. 1C illustrates the state of the fully-operational power system 110, where all grid-forming inverters and microgrids are active.

As illustrated in FIGS. 1A-1C, disclosed embodiments provide a technical improvement to black start processes. As illustrated in FIG. 1A, each of the microgrids are energized by their own anchor grid-forming inverter. This is a true black start unit that can generate its own sinusoidal reference and support the local critical MG load.

FIG. 1B illustrates the interconnection of the MGs occurring before the MGs are completely energized, that is, before other grid-forming inverters are connected to the grid.

Finally, FIG. 1C illustrates that remaining MGs are permitted to connect at random and do so if the system is stable. Note while the examples of that the only distinguished IBR technology in our method is a single grid-forming inverter; this can be done with any combination of grid-following or grid-forming inverter provided that the anchor in each MG is a grid-forming black start unit.

As described above, while a control system can be used to for more robust control of the power system and the SBs, the basic communication requirement of a disclosed black start method is minimal. Various embodiments only require binary on/off “enable” signals sent to the SBs to connect after an inverter is on in each MG. This enable signal can also serve to force close a breaker to energize a critical load in a neighboring MG has if it has either lost or was never equipped with its only grid-forming anchor inverter.

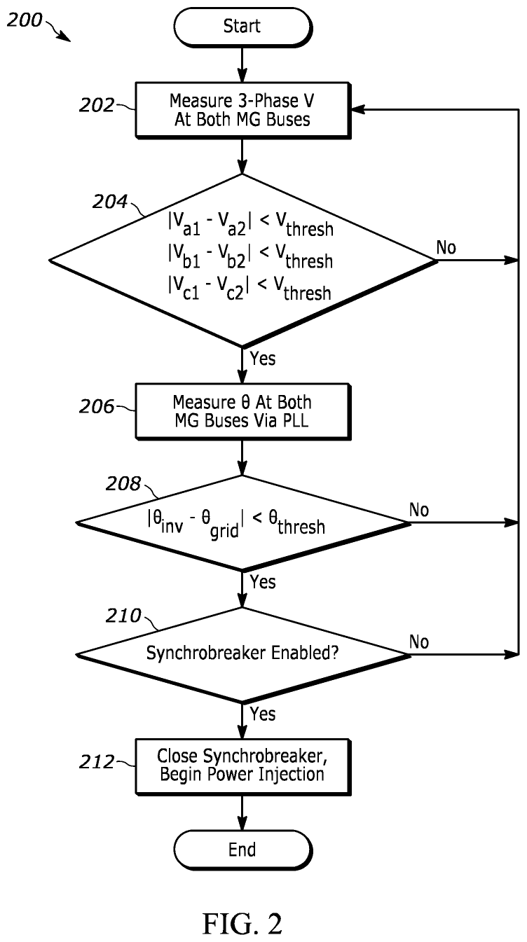

FIG. 2 illustrates an example of a process 200 in accordance with disclosed embodiments. The process of FIG. 2 can be performed by a synchrobreaker to determine whether to connect two microgrid buses. As above, this example assumes a three-phase system, but is similar to the process for a single-phase system.

The process starts when the SB detects power at each of the MB buses.

At 202, the SB measures the three-phase voltage at each MG bus.

At 204, the SB determines a voltage difference between corresponding phases of each bus, and determines whether the voltage difference between corresponding phases of each bus are within a voltage difference threshold:

$$\vert {V}_{a 1} - {V}_{a 2} \vert < {V}_{thresh}$$

$$\vert {V}_{b 1} - {V}_{b 2} \vert < {V}_{thresh}$$

$$\vert {V}_{c 1} - {V}_{c 2} \vert < {V}_{thresh}$$

where Vₜₕᵣₑₛₕ is the voltage difference threshold, Vₐ₁ is the voltage at a first MG for the first phase, Vₐ₂ is the voltage at a second MG for the first phase, V_{b1} is the voltage at the first MG for the second phase, V_{b2} is the voltage at the second MG for the second phase, Vel is the voltage at the first MG for the third phase, and V_{c2} is the voltage at the second MG for the third phase. If all three voltage differences are not within the voltage difference threshold, the process returns to 202 to continue measuring the voltages. If all three voltage differences are within the voltage difference threshold, the process continues to 206.

At 206, the system measures the phase angle Θ at both MG buses via phase locked loop (PLL).

At 208, the SB determines whether the phase angle difference between the two buses is within a phase difference threshold:

$$\vert {θ}_{inv} - {θ}_{grid} \vert < {θ}_{t h r e s h}$$

where Θᵢₙᵥ is the phase angle of the first inverter (or grid or migrogrid), Θ_{grid} is the phase angle of the second inverter (or grid or migrogrid), and Θₜₕᵣₑₛₕ is the phase angle difference threshold. If the phase angle difference is not within the phase difference threshold, the process returns to 202 to continue measuring the voltages. If the phase angle difference is within the phase difference threshold, the process continues to 210.

At 210, the SB determines whether it is enabled based on the state of the enable signal. In different cases, this could be indicated by the enable signal being high, being low, or otherwise. If the SB is not enabled, the process returns to 202 to continue measuring the voltages. If the SB is enabled, the process continues to 212.

At 212, since the connection criteria are met, the SB “closes” to operatively connect the two buses and begin power injection.

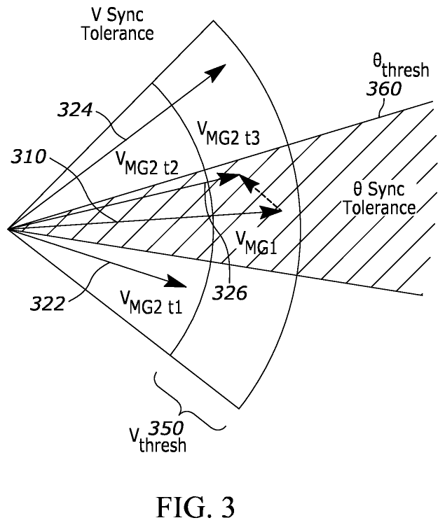

FIG. 3 illustrates various connection criteria in a phasor diagram for connecting a first microgrid MG1 and a second microgrid MG2. The synchrobreaker will only close and connect the MG1 and MG2 at t3 because the voltage phasors are within the tolerance.

That is, in this example, this figure shows the voltage V of MG1 as V_{MG1} 310. The voltage measurement of MG2 is shown at time t1 as V_{MG2t1} 322, at time t2 as V_{MG2t2} 324, and at time t3 as V_{MG2t3} 326. Voltage difference threshold Vₜₕᵣₑₛₕ 350 and phase angle difference threshold Θₜₕᵣₑₛₕ 360 are also illustrated. Non-limiting examples of thresholds that can be effective in some implementations are voltage difference threshold Vₜₕᵣₑₛₕ 350=˜4.8 volts and phase angle difference threshold Θₜₕᵣₑₛₕ 360=˜11.46. An exemplary frequency difference threshold between the two buses connected by an SB is 0.5.

At t1, V_{MG2t1} 322 is not within voltage difference threshold Vₜₕᵣₑₛₕ 350 or phase angle difference threshold Θₜₕᵣₑₛₕ 360 of V_{MG1} 310, so the connection criteria are not met. At t2, V_{MG2t2} 324 is within voltage difference threshold Vₜₕᵣₑₛₕ 350 of V_{MG1} 310 but is not within phase angle difference threshold Θₜₕᵣₑₛₕ 360 of V_{MG1} 310, so the connection criteria are not met. At t3, however, V_{MG2t3} 326 is within voltage difference threshold Vₜₕᵣₑₛₕ 350 and is also within phase angle difference threshold Θₜₕᵣₑₛₕ 360 of V_{MG1} 310, so the connection criteria are met. If the SB is also enabled, then the SB can be closed for power injection.

One major benefit to the disclosed SB techniques is the passive connection capabilities; the SB can wait until the voltage phasors are within the predefined thresholds before closing autonomously.

Disclosed embodiments describe a minimum-resource, multiple-microgrid black start because it can energize and synchronize multiple MGs with absolute minimum grid forming inverter-driven generation technology. Additionally, disclosed techniques can operate with less than one anchor inverter in each microgrid if the synchrobreakers are forced closed to energize a downed bus and therefore reach loads in other, physically distant MGs.

Such a minimum-resource bottom-up black start process reduces the impact of switching events and microgrid synchronization. In such a process, as disclosed above, only one inverter in each isolated MG need be enabled and connected when the SBs passively connect the MGs. Once the MGs are synchronized, other inverters may turn on at random to fully energize the system. In this process, the anchor inverter in each MG black starts to energize its own load and bus; the SBs are open.

Next, the SBs are permitted to connect; no other inverters are required to be turned on until the MGs are synchronized.

Finally, the rest of the inverters connect at random when they synchronize with the grid phasor. This approach allows the MGs to connect as soon as possible with a reduced number of inverters. When fewer inverters are connected to each minimum-MG, the transience when interconnecting MGs is less than when compared to fully-energized MGs.

To minimize disturbances when connecting an inverter or a MG to a grid, differences in voltage magnitude, phase, and frequency should be minimized. Because frequency and phase are physically coupled, one can only reduce their instantaneous phase difference by maintaining a frequency mismatch.

As described herein, MGs have lower system inertia than bulk grids, and so are more sensitive to switching events, e.g., connecting or disconnecting breakers that interface MGs to the grid (or other MGs) as well as connecting or disconnecting individual generation and load units. Consequently, MGs are also more likely to be downed by unexpected events such as the sudden loss of a generation or load unit or short circuit. These events, in addition to MG protection schemes, blackout detection, soft starts unbalanced systems, faults, and over/under voltage and frequency events may all lead to circumstances requiring a black start.

Disclosed techniques can be employed in a multi-MG “bottom-up” black start, where each MG is individually powered up by its own black-start unit. Other inverters then synchronize and connect. When the inverters are sharing the load and maintain a steady frequency and voltage, the SBs are given the enable signal. At this point, the SBs wait to close until the two MGs are synchronized.

In such a bottom-up black start process, the anchor inverter in each MG black starts to energize its own load bus. The SBs are open. For example, in the context of the power system 100 of FIG. 1A, anchor inverters 112, 122, 132, and 142 are first energized.

Next, the second inverter in each MG, such as inverters 114, 124, 134, and 144, closes its breaker when synchronized and shares power via droop with the anchor inverter of that MG.

Next, the third inverter in each MG, such as inverters 116, 126, 136, and 146, follows the same process as the second inverter.

The MGs are now fully energized but not synchronized. Finally, the SBs 150, 160, 170 close at their next opportunity (when the connection criteria are met) and connect the MGs.

Another disclosed approach is a top-down forced-sync black start. In this process, again using the example of power system 100, only one inverter in the system, e.g. inverter 122, is used as the anchor black-start unit. Inverter 122 first energizes its own MG 120. Then, the SBs 150, 170, and 160 close one by one so that the anchor inverter establishes a voltage to all buses.

In this approach, the SBs are forced to close (despite not meeting connection criteria as described above) and voltage is now available for all inverters to synchronize to. Only critical loads in other MGs should be energized at this point to avoid overloading.

Remaining inverters can then connect and load breakers are closed one by one leading to the full recovery. Finally, any remaining inverters are enabled and connect when synchronized with the grid.

A top-down forced-sync black start as described herein can energize critical loads in physically-distant MGs by taking advantage of energy resources in another local MG. This technique is particularly useful in worst-case-scenario power system failures. The minimum-resource bottom-up black start process and the non-minimum-resource bottom-up black start process, described above do not permit the closure of a SB until both voltage phasors are detected to be within the thresholds on both buses so that the connection criteria are met. In the event that a local MG has lost all of its generation capacity, the SB will not close. The top-down forced-sync black-start method is the only potential avenue to energize different MG loads by disregarding connection criteria and forcing closure/activation of the SBs.

As a result, the top-down forced-sync black start requires the anchor inverter to be rated at higher power than ones using other disclosed approaches, to sustain potentially higher baseline/minimum loads as well as inrush currents from other MGs. To achieve a successful black start, firstly, the baseline loads should not exceed the power rating of the single anchor inverter. Second, the power flow from one MG to another should not exceed the line limits. Third, care must be taken when forcing a breaker to close and energizing a downed line due to arcing and possible faults on the blacked-out MG.

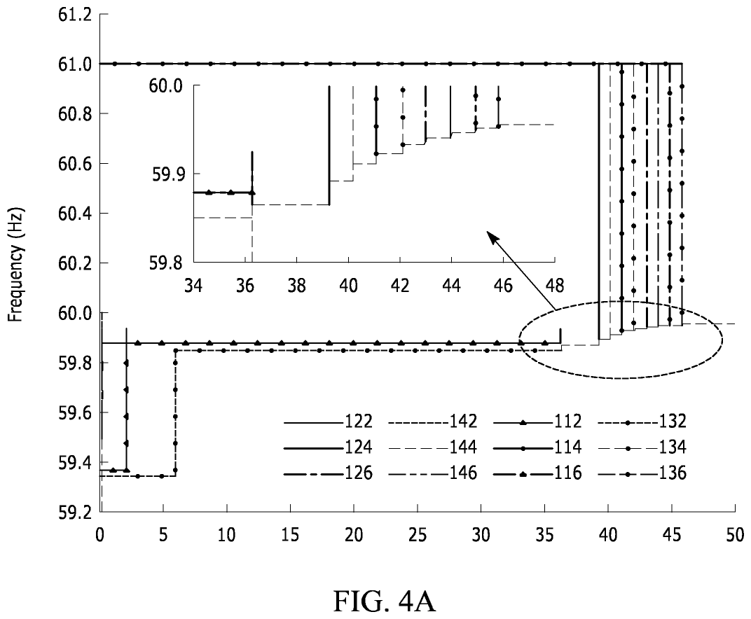

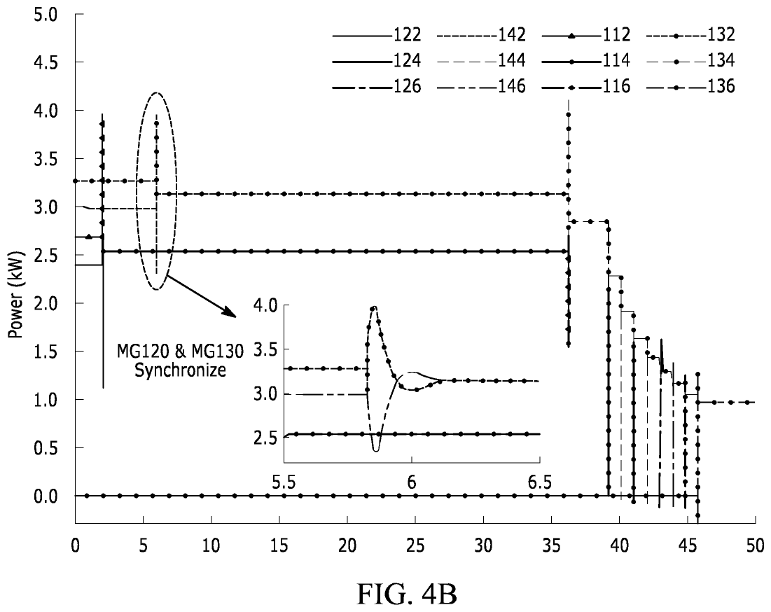

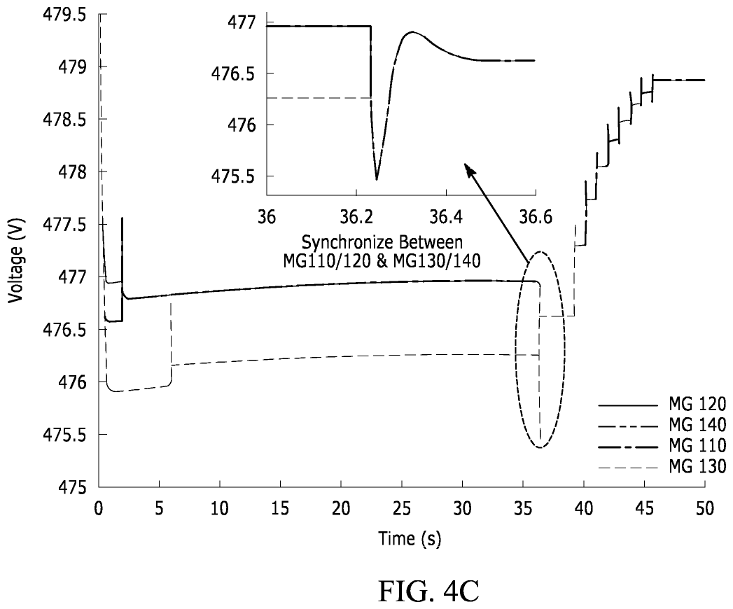

FIGS. 4A-4C illustrate exemplary frequency plots of a minimum-resource, multiple-microgrid black start process in accordance with disclosed embodiments, using the structure of power system 100 as illustrative and corresponding to the description of the exemplary minimum-resource, multiple-microgrid black start process above.

The frequency plots of FIGS. 4A-4C illustrate the individual inverter “enter service” procedure in exemplary, non-limiting embodiments. In this example, each inverter operates at 61 Hz until it is connected as seen in the frequency plots of FIGS. 4A-4C. This can reduce the time it takes for each inverter to connect during the black start. When the inverter is synchronized with the grid and its breaker closes, the internal frequency reference can then be switched from 61 to 60 Hz and droop control can be enabled. Because frequency and instantaneous phase are intrinsically coupled, the frequency mismatch between the two signals can be increased in order to modify the difference in instantaneous phase between the two signals.

IEEE 1547 describes that an inverter should not enter service when the grid operates below 59.5 Hz or above 60.1 Hz, but this requirement can be disregarded for black-start purposes, to be reapplied before the MG (or combined MGs) enters service.

By adding a constant deviation to the measured grid frequency reference, an inverter will be guaranteed to drift in and out of phase with the grid. This example uses a 1 Hz deviation, but as little as a 0.1 Hz deviation can be sufficient in a real microgrid black start.

In this example, the MGs are energized independently, and the inverters are enabled one at a time on the MGs in ascending power level. As shown in FIGS. 4A-4C, the frequency and voltage of each MG recover as the inverters come online and share more power. The initial anchor inverter that turns on in each MG is stable. In this example, the anchor inverter 122 of MG 120 is energized first, then the anchor inverter 112 of MG 110, then the anchor inverter 142 of MG 140, then the anchor inverter 132 of MG 130. When all of the inverters are injecting power to their respective local MGs, the SB synchronization is enabled.

MG 110 syncs to MG 120 and MC 130 syncs to MC 140. When those syncronizations are stable, MGs 110/120 sync to MGs 130/140. A salient result of this simulation is that it took ≈47s for the combination of MGs 110/120 to sync with the combination of MGs 130/140. This time delay is caused by the difference in phase seen at both sides of the SB. Because the frequencies of the two MG combinations are so close, the phase difference changes very slowly. Only when the phase difference is below the threshold does the final SB close and the whole system is connected. The frequencies of the MGs are not exactly the same due to the relationship stated in eq. (1). Note that there is no secondary control to correct frequency deviations; the SB operates passively between two MGs. There is minimal transience in frequency, power, and voltage during the MG interconnection events.

After sync, the remaining inverters can connect at random or in controlled order without disturbing the operation of the power system, enabling a rapid, stable black start.

This method prioritizes the early synchronization of multiple MGs and also has the added benefit of less transience during switching events other approaches.

The minimum-resource, multiple-microgrid black start process disclosed herein can complete the MG synchronization and energization in 47s or less, much more quickly that other approaches, and therefore provides a significant advantage over other black-start techniques. This significant improvement can be attributed to the frequency difference between the combination of MGs 110 and 120 and the combination of MGs 130 and 140.

As illustrated in these figures, the disclosed minimum-resource, multiple-microgrid black start process produces visibly reduced transience in frequency, power, and voltage upon MG interconnection in comparison to other processes.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

Other relevant discussion of related issues may be found in the following documents, all of which are incorporated by reference:
B.-M. S. Hodge, H. Jain, C. Brancucci, G.-S. Seo, M. Korpas, J. Kiviluoma, H. Holttinen, J. C. Smith, A. Orths, A. Estanqueiro et al., “Addressing technical challenges in 100% variable inverter-based renewable energy power systems,” Wiley Interdisciplinary Reviews: Energy and Environment, vol. 9, no. 5, p. e376, 2020.
P. Denholm, P. Brown, and W. Cole, “Examining supply-side options to achieve 100% clean electricity by 2035,” National Renewable Energy Lab. (NREL), Golden, CO (United States), Tech. Rep., 2022.
H. Jain, G.-S. Seo, E. Lockhart, V. Gevorgian, and B. Kroposki, “Black start of power grids with inverter-based resources,” in Proc. IEEE Power & Energy Society General Meetings, 2020, pp. 1-5.
A. Banerjee, A. Pandey, U. R. Pailla, G.-S. Seo, S. Shekhar, H. Jain, Y. Lin, X. Wu, J. Bamberger, and U. Muenz, “Autonomous microgrid restoration using grid-forming inverters and smart circuit breakers,” in IEEE Power & Energy Society General Meeting, 2022, pp. 1-5.
S. Li, Q. Yu, H. Zhang, S. Gao, Y. Song, D. Wang, and J. Tang, “A hierarchical multi-agent evaluation scheme for integrating distributed energy resources in distribution systems,” in International Conference on Renewable Power Generation (RPG2015), 2015, pp. 1-6.
Y. Lin, J. H. Eto, B. B. Johnson, J. D. Flicker, R. H. Lasseter, H. N. Villegas Pico, G.-S. Seo, B. J. Pierre, and A. Ellis, “Research roadmap on grid-forming inverters,” National Renewable Energy Lab. (NREL), Golden, CO (United States), Tech. Rep., 2020.
S. Xu, Y. Xue, and L. Chang, “Review of power system support functions for inverter-based distributed energy resources-standards, control algorithms, and trends,” IEEE OpenJ. Power Electron., vol. 2, pp. 88-105, 2021.
D. Chakravorty, D. Gutschow, X. Zhang, N. Miller, and D. Auty, “System restoration strategies using distributed energy resources,” in CIRED 2021—The 26^{th} International Conference and Exhibition on Electricity Distribution, vol. 2021, 2021, pp. 1445-1449.
I. Beil, A. Allen, A. Tokombayev, and M. Hack, “Considerations when using utility-scale battery storage to black start a gas turbine generator,” in IEEE Power & Energy Society General Meeting, 2017, pp. 1-5.
Y. Du, H. Tu, X. Lu, J. Wang, and S. Lukic, “Black-start and service restoration in resilient distribution systems with dynamic microgrids,” IEEE J. Emerg. Sel. Topics Power Electron., pp. 1-1, 2021.
F. Sadeque, D. Sharma, and B. Mirafzal, “Multiple grid-forming inverters in black-start: The challenges,” in IEEE Workshop on Control and Modelling of Power Electronics (COMPEL), 2021, pp. 1-6.
Y. Zhao, Z. Lin, Y. Ding, Y. Liu, L. Sun, and Y. Yan, “A model predictive control based generator start-up optimization strategy for restoration with microgrids as black-start resources,” IEEE Trans. PowerSys., vol. 33, no. 6, pp. 7189-7203, 2018.
Y. Du, H. Tu, and S. Lukic, “Distributed control strategy to achieve synchronized operation of an islanded mg,” IEEE Transactions on SmartGrid, vol. 10, no. 4, pp. 4487-4496, 2019.
“IEEE guide for using IEEE std 1547 for interconnection of energy storage distributed energy resources with electric power systems,” IEEE Std1547. 9-2022, pp. 1-87, 2022.
Sherif Fahmy, Quentin Walger, and Mario Paolone, “Resynchronization of islanded unbalanced ADNs: Control, synchrocheck and experimental validation,” Electric Power Systems Research 211, 2022.
“Black Start,” National Renewable Energy Lab, www.nrel.gov/grid/black-start.html, retrieved May 9, 2023.
Elliott Fix, Abhishek Banerjee, Ulrich Muenz, and Gab-Su Seo, “Investigating Multi-Microgrid Black Start Methods Using Grid-Forming Inverters,” IEEE Conference on Innovative Smart Grid Technologies North America (ISGT NA), January 2023.

None of the description in the present application should be read as implying that any particular element, step, or function is an essential element which must be included in the claim scope: the scope of patented subject matter is defined only by the allowed claims. Moreover, none of these claims are intended to invoke 35 USC § 112 (f) unless the exact words “means for” are followed by a participle. The use of terms such as (but not limited to) “mechanism,” “module,” “device,” “unit,” “component,” “element,” “member,” “apparatus,” “machine,” “system,” “processor,” or “controller,” within a claim is understood and intended to refer to structures known to those skilled in the relevant art, as further modified or enhanced by the features of the claims themselves, and is not intended to invoke 35 U.S.C. § 112 (f).

1. A process for performing a black start in a power system, comprising:
starting a first anchor grid-forming inverter in a first microgrid and starting a second anchor grid-forming inverter in a second microgrid, wherein the first microgrid is connected to a first bus and the second microgrid is connected to a second bus;
measuring a first voltage at the first bus and measuring a second voltage at the second bus;
determining a voltage difference between the first bus and the second bus;
determining whether the voltage difference is within a voltage difference threshold;
measuring a first phase angle at the first bus and measuring a second phase angle at the second bus;
determining a phase angle difference between the first bus and the second bus;
determining whether the phase angle difference is within a phase angle difference threshold;
when the voltage difference is within the voltage difference threshold and the phase angle difference is within the phase angle difference threshold, then operatively connecting the first bus to the second bus.

2. The method of claim 1, further comprising determining whether an enable signal is active, and only operatively connecting the first bus to the second bus when the enable signal is active.

3. The method of claim 1, wherein the first phase angle and the second phase angle are measured using phase locked loop.

4. The method of claim 1, further comprising thereafter starting at least one other inverter in the first microgrid.

5. The method of claim 1, further comprising thereafter operatively connecting at least one other microgrid to the first microgrid and the second microgrid based on a voltage difference and a phase angle difference between the other microgrid and the connected first microgrid and second microgrid.

6. The method of claim 1, wherein each microgrid includes multiple other inverters, and each of the other inverters in each microgrid are started at random after the first microgrid has been operatively connected to the second microgrid.

7. The method of claim 1, wherein the first anchor grid-forming inverter and the second anchor grid-forming inverter each produce three-phase electric power, and the measuring and determining steps are each performed with respect to corresponding phases of first bus and the second bus.

8. A power system having a plurality of microgrids, each microgrid having a plurality of inverter-based resources, at least one inverter-based resource in each microgrid being an anchor grid-forming inverter, each microgrid operatively connectable to at least one other microgrid by a synchrobreaker, the power system configured to perform the process as claimed in claim 1.
